(19) United States
(12) Patent Application Publication
(10) Pub. No.: US 2016/0160758 A1
(43) Pub. Date: Jun. 9, 2016

(54) GAS TURBINE ENGINE NACELLE ANTI-ICING SYSTEM

(71) Applicant: United Technologies Corporation, Farmington, CT (US)

(72) Inventor: Ian T. Marchaj, Windsor Locks, CT (US)

(21) Appl. No.: 14/947,174

(22) Filed: Nov. 20, 2015

Related U.S. Application Data
(60) Provisional application No. 62/089,016, filed on Dec. 8, 2014.

(51) Int. Cl. F02C 7/047

(52) U.S. Cl. CPC F02C 7/047

(57) ABSTRACT

A gas turbine engine de-icing system includes a heat exchanger. A coolant loop is in fluid communication with the heat exchanger and is configured to circulate a coolant. An engine oil loop is in fluid communication with the heat exchanger and is configured to transfer heat to the coolant. A gas turbine engine inlet structure includes a cavity. A manifold is arranged in the cavity and is in fluid communication with the coolant loop. The manifold is configured to spray the coolant onto the gas turbine engine inlet structure to de-ice the gas turbine engine inlet structure.

### CROSS-REFERENCE TO RELATED APPLICATIONS

This application claims priority to U.S. Provisional Application No. 62/089,016, which was filed on Dec. 8, 2014 and is incorporated herein by reference.

### BACKGROUND

This disclosure relates to a gas turbine engine de-icing system used, for example, for a fan nacelle.

A gas turbine engine typically includes a fan section, a compressor section, a combustor section and a turbine section. Air entering the compressor section is compressed and delivered into the combustor section where it is mixed with fuel and ignited to generate a high-speed exhaust gas flow. The high-speed exhaust gas flow expands through the turbine section to drive the compressor and the fan section. The compressor section typically includes low and high pressure compressors, and the turbine section includes low and high pressure turbines.

Gas turbine engine inlet components, such as the fan nacelle, are subject to icing during some engine operating conditions. Ice accumulation at the engine inlet can adversely impact engine operation. To this end, de-icing systems are used to melt any ice on the engine's inlet surfaces.

One example de-icing system uses electrically operated resistive elements embedded in the nacelle inlet walls. These resistive elements are powered by a generator driven by the engine. The generators must be sized to power the resistive elements, which represent a parasitic load on the engine.

Another example de-icing system uses a spray ring arranged in a D-duct, which provides the inlet surface of the fan nacelle. Bleed air from the compressor section is provided to the spray ring to direct hot air onto the inlet wall. Since work has already been done to this hot air by the compressor section, engine efficiency is reduced.

### SUMMARY

In one exemplary embodiment, a gas turbine engine de-icing system includes a heat exchanger and a coolant loop that is in fluid communication with the heat exchanger and is configured to circulate a coolant. An engine oil loop is in fluid communication with the heat exchanger and is configured to transfer heat to the coolant. A gas turbine engine inlet structure includes a cavity. A manifold is arranged in the cavity and is in fluid communication with the coolant loop. The manifold is configured to spray the coolant onto the gas turbine engine inlet structure to de-ice the gas turbine engine inlet structure.

In a further embodiment of the above, the heat exchanger is arranged in a passageway and is configured to be exposed to an airflow.

In a further embodiment of any of the above, there is a fan nacelle and a core nacelle that provide a bypass flow path. The passageway is in fluid communication with the bypass flow path.

In a further embodiment of any of the above, a door is arranged in the passageway. A controller is configured to operatively communicate with the door to selectively regulate the airflow through the passageway.

In a further embodiment of any of the above, the coolant is a phase change fluid.

In a further embodiment of any of the above, the coolant changes phase from a liquid to a gas or saturated vapor in a range of 200° F.-500° F. (93° C.-260° C.).

In a further embodiment of any of the above, the gas turbine engine inlet structure is a fan nacelle and the manifold is an annular spray bar that is arranged in the fan nacelle.

In a further embodiment of any of the above, the coolant loop includes a reservoir and a pump that is configured to circulate the coolant. The reservoir is arranged downstream from the manifold and is configured to collect the liquid.

In a further embodiment of any of the above, at least one of a gearbox and bearing system is in fluid communication with the engine oil loop.

In a further embodiment of any of the above, the gearbox operatively connects a turbine section to a fan section.

In another exemplary embodiment, a method of de-icing a gas turbine engine component comprising the steps of circulating an engine oil to a heat exchanger, rejecting heat from the engine oil to a coolant, circulating the coolant to an gas turbine engine inlet component and de-icing the gas turbine engine inlet component with the coolant.

In a further embodiment of the above, the engine oil circulating step includes pumping the engine oil from at least one of a gearbox and bearing system.

In a further embodiment of any of the above, the heat exchanger is arranged in a passageway and the method comprises the step of providing an airflow through the passageway to cool the engine oil.

In a further embodiment of any of the above, the method includes the step of regulating the airflow through the passageway based upon a desired heat transfer within the heat exchanger.

In a further embodiment of any of the above, the coolant is a phase change fluid. The method comprising the step of spraying gaseous or saturated vapor coolant onto the gas turbine engine inlet component to de-ice the gas turbine engine inlet component and condensing the gaseous or saturated vapor coolant to a liquid coolant with the de-iced gas turbine engine inlet component.

In a further embodiment of any of the above, the method includes the step of collecting the condensed liquid coolant in a reservoir.

In another exemplary embodiment, a gas turbine engine de-icing system includes a fan nacelle and a core nacelle that provide a bypass flow path. The fan nacelle includes a cavity, a turbine section and a fan section operatively connected by a gearbox. A passageway is configured to be exposed to an airflow from the bypass flow path. A heat exchanger and a coolant loop is in fluid communication with the heat exchanger and is configured to circulate a coolant. An engine oil loop is in fluid communication with the heat exchanger and is configured to transfer heat to the coolant. The gearbox is arranged in the engine oil loop. A manifold is arranged in the cavity and is in fluid communication with the coolant loop. The manifold is configured to spray the coolant onto the gas turbine engine inlet structure to de-ice the fan nacelle.

In a further embodiment of any of the above, a door is arranged in the passageway. A controller is configured to operatively communicate with the door to selectively regulate the airflow through the passageway.

In a further embodiment of any of the above, the coolant is a phase change fluid.

In a further embodiment of any of the above, the coolant changes phase from a liquid to a gas in a range of 200° F.-500° F. (93° C.-260° C.).

### BRIEF DESCRIPTION OF THE DRAWINGS

The disclosure can be further understood by reference to the following detailed description when considered in connection with the accompanying drawings wherein:

FIG. 1 schematically illustrates a gas turbine engine embodiment.

FIG. 2 is a schematic view of a portion of the example de-icing system.

FIG. 3 schematically illustrates another portion of the de-icing system shown in FIG. 2.

FIG. 4 is a phase change diagram of the coolant used in the de-icing system.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### DETAILED DESCRIPTION

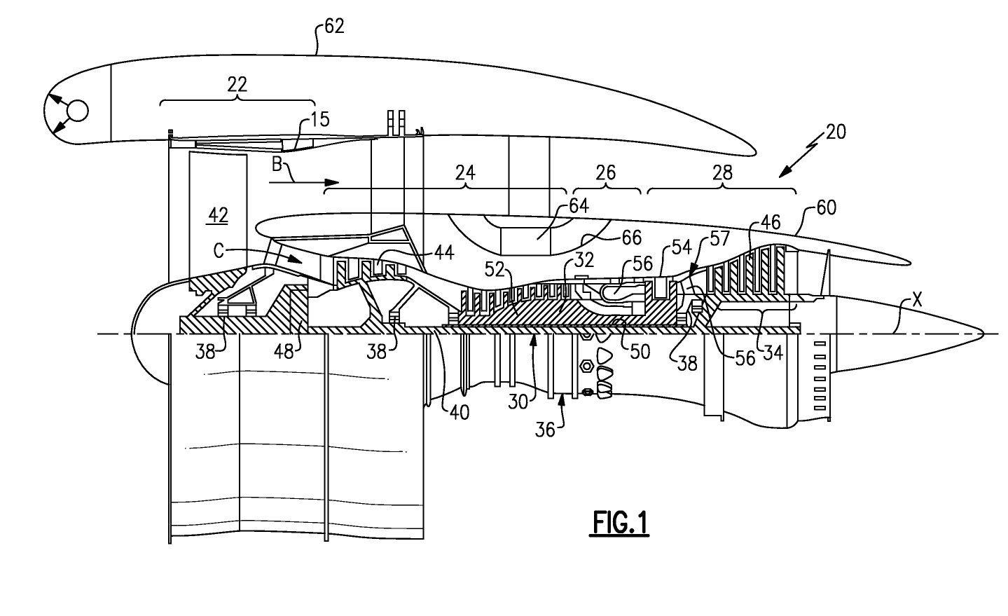

FIG. 1 schematically illustrates a gas turbine engine 20. The gas turbine engine 20 is disclosed herein as a two-spool turbofan that generally incorporates a fan section 22, a compressor section 24, a combustor section 26 and a turbine section 28. Alternative engines might include an augmenter section (not shown) among other systems or features. The fan section 22 drives air along a bypass flow path B in a bypass duct 15 defined within a nacelle, while the compressor section 24 drives air along a core flow path C for compression and communication into the combustor section 26 then expansion through the turbine section 28. Although depicted as a two-spool turbofan gas turbine engine in the disclosed non-limiting embodiment, it should be understood that the concepts described herein are not limited to use with two-spool turbofans as the teachings may be applied to other types of turbine engines including three-spool architectures and single-spool architectures.

The exemplary engine 20 generally includes a low speed spool 30 and a high speed spool 32 mounted for rotation about an engine central longitudinal axis X relative to an engine static structure 36 via several bearing systems 38. It should be understood that various bearing systems 38 at various locations may alternatively or additionally be provided, and the location of bearing systems 38 may be varied as appropriate to the application.

The low speed spool 30 generally includes an inner shaft 40 that interconnects a fan 42, a first (or low) pressure compressor 44 and a first (or low) pressure turbine 46. The inner shaft 40 is connected to the fan 42 through a speed change mechanism, which in exemplary gas turbine engine 20 is illustrated as a geared architecture 48 to drive the fan 42 at a lower speed than the low speed spool 30. The high speed spool 32 includes an outer shaft 50 that interconnects a second (or high) pressure compressor 52 and a second (or high) pressure turbine 54. A combustor 56 is arranged in exemplary gas turbine 20 between the high pressure compressor 52 and the high pressure turbine 54. A mid-turbine frame 57 of the engine static structure 36 is arranged generally between the high pressure turbine 54 and the low pressure turbine 46. The mid-turbine frame 57 further supports bearing systems 38 in the turbine section 28. The inner shaft 40 and the outer shaft 50 are concentric and rotate via bearing systems 38 about the engine central longitudinal axis X which is collinear with their longitudinal axes.

The core airflow is compressed by the low pressure compressor 44 then the high pressure compressor 52, mixed and burned with fuel in the combustor 56, then expanded over the high pressure turbine 54 and low pressure turbine 46. The mid-turbine frame 57 includes airfoils 59 which are in the core airflow path C. The turbines 46, 54 rotationally drive the respective low speed spool 30 and high speed spool 32 in response to the expansion. It will be appreciated that each of the positions of the fan section 22, compressor section 24, combustor section 26, turbine section 28, and fan drive gear system 48 may be varied. For example, gear system 48 may be located aft of combustor section 26 or even aft of turbine section 28, and fan section 22 may be positioned forward or aft of the location of gear system 48.

The engine 20 in one example is a high-bypass geared aircraft engine. In a further example, the engine 20 bypass ratio is greater than about six (6), with an example embodiment being greater than about ten (10), the geared architecture 48 is an epicyclic gear train, such as a planetary gear system or other gear system, with a gear reduction ratio of greater than about 2.3 and the low pressure turbine 46 has a pressure ratio that is greater than about five. In one disclosed embodiment, the engine 20 bypass ratio is greater than about ten (10:1), the fan diameter is significantly larger than that of the low pressure compressor 44, and the low pressure turbine 46 has a pressure ratio that is greater than about five 5:1. Low pressure turbine 46 pressure ratio is pressure measured prior to inlet of low pressure turbine 46 as related to the pressure at the outlet of the low pressure turbine 46 prior to an exhaust nozzle. The geared architecture 48 may be an epicycle gear train, such as a planetary gear system or other gear system, with a gear reduction ratio of greater than about 2.3:1. It should be understood, however, that the above parameters are only exemplary of one embodiment of a geared architecture engine and that the present invention is applicable to other gas turbine engines including direct drive turbofans.

A significant amount of thrust is provided by the bypass flow B due to the high bypass ratio. The fan section 22 of the engine 20 is designed for a particular flight condition—typically cruise at about 0.8 Mach and about 35,000 feet (10,668 meters). The flight condition of 0.8 Mach and 35,000 ft (10,668 meters), with the engine at its best fuel consumption—also known as “bucket cruise Thrust Specific Fuel Consumption (‘TSFCT’)”—is the industry standard parameter of lbm of fuel being burned divided by lbf of thrust the engine produces at that minimum point. “Low fan pressure ratio” is the pressure ratio across the fan blade alone, without a Fan Exit Guide Vane (“FEGV”) system. The low fan pressure ratio as disclosed herein according to one non-limiting embodiment is less than about 1.45. “Low corrected fan tip speed” is the actual fan tip speed in ft/sec divided by an industry standard temperature correction of [(Tram ° R)/(518.7° R)]^{0.5}. The “Low corrected fan tip speed” as disclosed herein according to one non-limiting embodiment is less than about 1150 ft/second (350.5 meters/second).

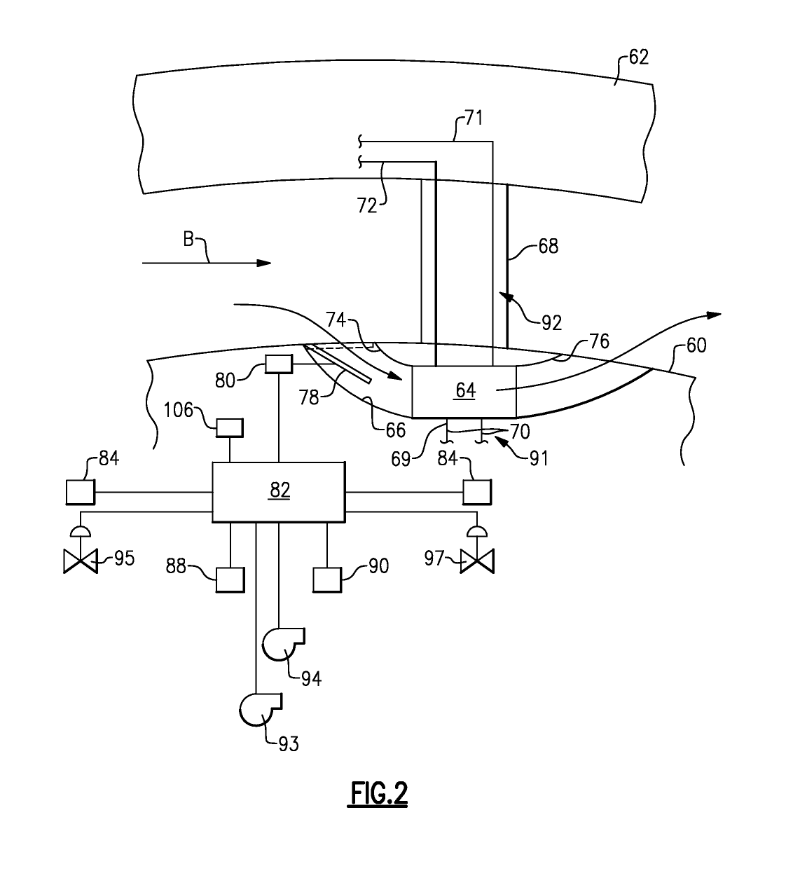

The engine 20 includes a core nacelle 60 and a fan nacelle 62. A fan nacelle 62 provides an inlet to the engine 20. A passageway 66 is arranged in the core nacelle 60 to provide an air flow from the bypass flow path through the passageway. A heat exchanger 64 is arranged in the passageway 66, as best shown in FIG. 2.

The heat exchanger 64 is in fluid communication with an engine oil loop 91 that includes oil lines 69, 70. A coolant loop 92 is also in fluid communication with the heat exchanger and includes coolant lines 71, 72. The coolant lines 72 extend from the heat exchanger 64 through a bifurcation 68 arranged in the bypass flow path and interconnecting the core nacelle 60 to the fan nacelle 62.

The passageway 66 provides an inlet 74 and an exit 76. Air flow through the passageway 66 may be selectively regulated by a door 78 that opens and closes in response to an actuator 80. A controller 82 communicates with the actuator 80 to command a position of the door 78 in response to inputs, such as a manual input 84 from a pilot or an automatic input 86 based upon an icing algorithm, for example. The controller 82 communicates with various sensors 88, 90, such as temperature and pressure sensors, which can be used to predict an icing condition and desired heat transfer characteristics of the heat exchanger based upon engine operation.

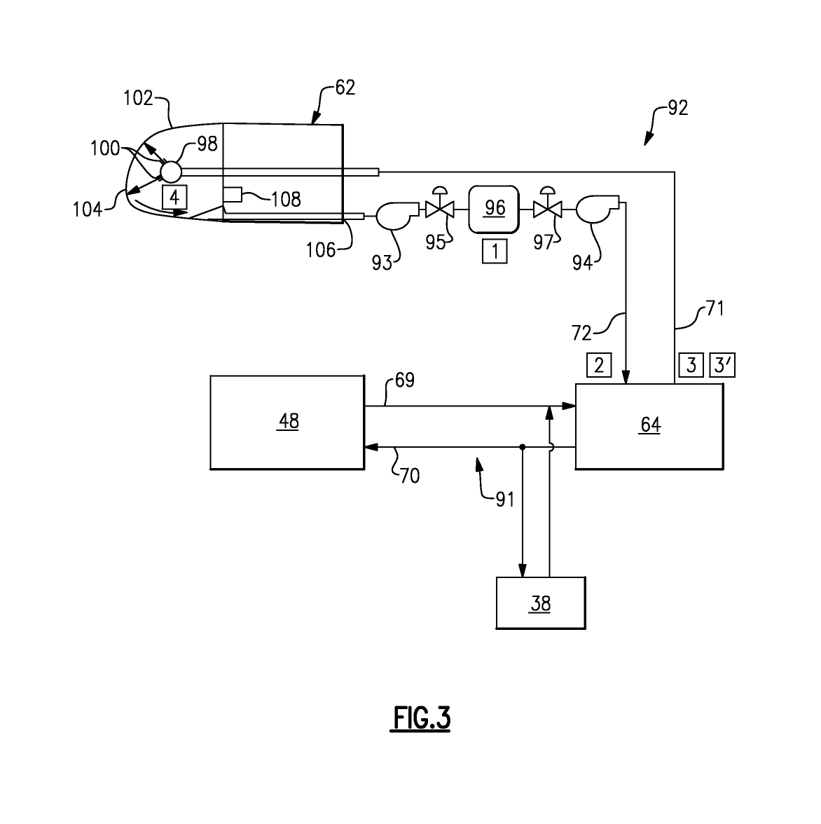

Referring to FIG. 3, the engine oil loop 91 circulates lubrication oil from the geared architecture 48 and/or the bearings 38 to the heat exchanger 64 for cooling. The coolant loop 92 circulates a coolant to a manifold, such as an annular spray bar 98, arranged in a cavity of the D-duct 102 of the fan nacelle 92.

The coolant is a phase change fluid, for example, that changes phase from a liquid to a gas or saturated vapor in an operating range of the engine oil, such as a range of 200° F.-500° F. (93° C.-260° C.). One example phase change fluid is ammonia 2,3,3,3-tetrafluoropropene, 2,2-dichloro-1,1,1-trifluoroethane, although it should be understood that other phase change fluids may also be used.

A fluid reservoir 96 and first and second pumps 93, 94 are arranged in the coolant loop 92. First and second valves 95, 97 are provided respectively between the first and second pumps 93, 94 and the reservoir 96.

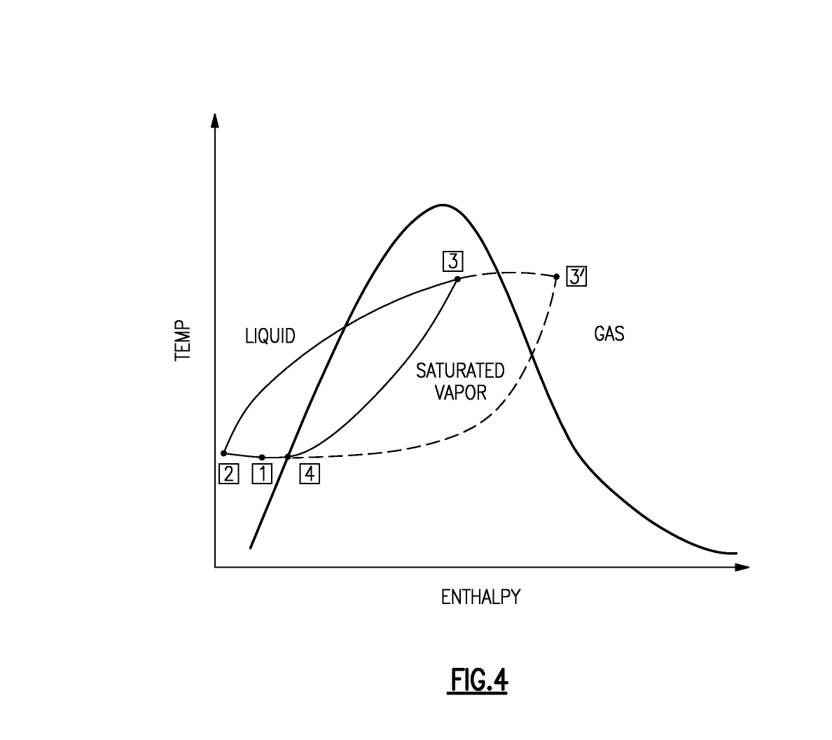

Referring to FIGS. 3 and 4, the coolant at location 1 is a liquid. The liquid coolant is pumped from the reservoir 96 with second pump 94 to the heat exchanger 64 to location 2 where heat is transferred from the engine oil to the coolant. The enthalpy of the liquid coolant is increased by the engine oil and circulated to the annular spray bar 98. The hot gaseous coolant is sprayed through holes 100 in the annular spray bar 98 as a saturated vapor 3 or a gas 3′ onto an inner surface of the D-duct 102. Ice on an exterior surface 104 of the D-duct 102 is melted as heat is transferred from the hot gaseous coolant or saturated vapor to the ice, which reduces the temperature of the gaseous coolant and condenses the coolant to a liquid at location 4.

The condensed liquid coolant flows from a drain 106 in the D-duct 102 back to the reservoir 96. A level sensor 108 communicates with the controller 82, which operates the first pump 93, which is used to maintain a desired condensate level within the reservoir 96. The first and second valves 95, 97, which are in communication with the controller 82, are operated to provide desired flow rates and volumes at various locations throughout the coolant loop 92.

It should also be understood that although a particular component arrangement is disclosed in the illustrated embodiment, other arrangements will benefit herefrom. For example, other gas turbine engine inlet structures may incorporate the disclosed de-icing arrangement. Although particular step sequences are shown, described, and claimed, it should be understood that steps may be performed in any order, separated or combined unless otherwise indicated and will still benefit from the present invention.

Although the different examples have specific components shown in the illustrations, embodiments of this invention are not limited to those particular combinations. It is possible to use some of the components or features from one of the examples in combination with features or components from another one of the examples.

Although an example embodiment has been disclosed, a worker of ordinary skill in this art would recognize that certain modifications would come within the scope of the claims. For that reason, the following claims should be studied to determine their true scope and content.

What is claimed is:

1. A gas turbine engine de-icing system comprising:
a heat exchanger;
a coolant loop in fluid communication with the heat exchanger and configured to circulate a coolant;
an engine oil loop in fluid communication with the heat exchanger and configured to transfer heat to the coolant; and
a gas turbine engine inlet structure including a cavity, and a manifold arranged in the cavity and in fluid communication with the coolant loop, the manifold configured to spray the coolant onto the gas turbine engine inlet structure to de-ice the gas turbine engine inlet structure.

2. The system according to claim 1, wherein the heat exchanger is arranged in a passageway configured to be exposed to an airflow.

3. The system according to claim 2, comprising a fan nacelle and a core nacelle that provide a bypass flow path, the passageway in fluid communication with the bypass flow path.

4. The system according to claim 3, comprising a door arranged in the passageway, and a controller configured to operatively communicate with the door to selectively regulate the airflow through the passageway.

5. The system according to claim 1, wherein the coolant is a phase change fluid.

6. The system according to claim 5, wherein the coolant changes phase from a liquid to a gas or saturated vapor in a range of 200° F.-500° F. (93° C.-260° C.).

7. The system according to claim 5, wherein the gas turbine engine inlet structure is a fan nacelle, and the manifold is an annular spray bar arranged in the fan nacelle.

8. The system according to claim 7, wherein the coolant loop includes a reservoir and a pump configured to circulate the coolant, the reservoir arranged downstream from the manifold and configured to collect the liquid.

9. The system according to claim 1, comprising at least one of a gearbox and bearing system in fluid communication with the engine oil loop.

10. The system according to claim 9, wherein the gearbox operatively connects a turbine section to a fan section.

11. A method of de-icing a gas turbine engine component comprising the steps of:
circulating an engine oil to a heat exchanger;
rejecting heat from the engine oil to a coolant;
circulating the coolant to an gas turbine engine inlet component; and
de-icing the gas turbine engine inlet component with the coolant.

12. The method according to claim 11, wherein the engine oil circulating step includes pumping the engine oil from at least one of a gearbox and bearing system.

13. The method according to claim 11, wherein the heat exchanger is arranged in a passageway, and comprising the step of providing an airflow through the passageway to cool the engine oil.

14. The method according to claim 13, comprising the step of regulating the airflow through the passageway based upon a desired heat transfer within the heat exchanger.

15. The method according to claim 11, wherein the coolant is a phase change fluid, and comprising the step of spraying gaseous or saturated vapor coolant onto the gas turbine engine inlet component to de-ice the gas turbine engine inlet component, and condensing the gaseous or saturated vapor coolant to a liquid coolant with the de-iced gas turbine engine inlet component.

16. The method according to claim 15, comprising the step of collecting the condensed liquid coolant in a reservoir.

17. A gas turbine engine de-icing system comprising:
a fan nacelle and a core nacelle that provide a bypass flow path, the fan nacelle includes a cavity;
a turbine section and a fan section operatively connected by a gearbox;
a passageway configured to be exposed to an airflow from the bypass flow path;
a heat exchanger;
a coolant loop in fluid communication with the heat exchanger and configured to circulate a coolant;
an engine oil loop in fluid communication with the heat exchanger and configured to transfer heat to the coolant, the gearbox arranged in the engine oil loop; and
a manifold arranged in the cavity and in fluid communication with the coolant loop, the manifold configured to spray the coolant onto the gas turbine engine inlet structure to de-ice the fan nacelle.

18. The system according to claim 17, comprising a door arranged in the passageway, and a controller configured to operatively communicate with the door to selectively regulate the airflow through the passageway.

19. The system according to claim 17, wherein the coolant is a phase change fluid.

20. The system according to claim 19, wherein the coolant changes phase from a liquid to a gas in a range of 200° F.-500° F. (93° C.-260° C.).
